(19) United States
(12) Patent Application Publication
(10) Pub. No.: US 2007/0214119 A1
(43) Pub. Date: Sep. 13, 2007

(54) Searching within a Site of a Search Result

(75) Inventors: Ethan Ray, Redmond, WA (US); Rodney C. Edwards, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/560,296

(22) Filed: Nov. 15, 2006

Related U.S. Application Data
(60) Provisional application No. 60/743,425, filed on Mar. 7, 2006.

(51) Int. Cl. G06F 17/30

(52) U.S. Cl. 707/3

(57) ABSTRACT

Searching within a site of a search result is enabled with a user interface, a method, etc. that presents a search within a site tool indicator in association with at least one search result of multiple displayed search results. The at least one search result corresponds to a given page of a particular site. The search within a site tool indicator may be employed by a user to search the particular site.

### BACKGROUND

The internet contains a wealth of information. In fact, the types of information are so varied and the amount of information is so great that it is difficult to find information without using some kind of search tool. Search tools are powered by search engines, many of which operate differently from one another. For example, searches may be based on key word search targets. The returned search results often differ from one search engine to another depending on the mechanism employed to crawl the internet and to index the information that is encountered during the crawling. The returned search results may also differ based on the search result ranking mechanism employed by a search engine.

Typically, a key word search target input is applied to the entirety of the internet that a search engine has crawled and indexed. Regardless of the underlying indexing and ranking mechanisms that are used, search results are usually returned by search engines in a listing format. A given returned search result listing is therefore for a given key word search target input that has been applied to the crawled and indexed portion of the internet. To peruse the search results listing, a user clicks on each individual search result that appears to be promising. The page corresponding to the selected search result is then loaded and displayed.

### SUMMARY

Searching within a site of a search result is enabled with a user interface, a method, etc. that presents a search within a site tool indicator in association with at least one search result of multiple displayed search results. The at least one search result corresponds to a given page of a particular site. The search within a site tool indicator may be employed by a user to search the particular site.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is an example environment in which searching within a site of a search result may be implemented.

FIG. 2 is an example user interface having selectable categories and a search results area in which a site that is associated with a displayed search result may itself be searched.

FIG. 3 is a block diagram of a more general example of a search results area in which a site that is associated with a displayed search result may itself be searched.

FIG. 4 is a block diagram of a search result for a page on a site in which a user interface enables the site to be searched.

FIG. 5 is another block diagram of a search result for a page on a site in which a user interface enables the site to be searched.

FIG. 6 is yet another block diagram of a search result for a page on a site in which a user interface enables the site to be searched.

FIG. 7 is a flow diagram that illustrates an example of a method for searching a site of a page that corresponds to a displayed search result.

FIG. 8 is a block diagram of an example device that may be employed in conjunction with searching within a site of a search result.

### DETAILED DESCRIPTION

### Introduction

As described above, search engines usually return search results to browsers in a listing format. To peruse the search results, a user clicks on each individual search result that appears to be promising. The search result is then displayed in a different browser window or in place of the search result listing in the same browser window. From time to time, from reading the search result listing and/or from reviewing the corresponding page, a user might decide that the overall site on which the page is located may provide additional relevant information. However, existing search interfaces do not provide a mechanism for searching the underlying site.

In contrast, certain described implementations for searching within a site of a search result enable an underlying site that is associated with a search result to be searched. More specifically, a site associated with a page that corresponds to a displayed search result may be searched. For example, a user interface may present a search within a site tool indicator. Activating the search within a site tool indicator causes a search within a site search input interface to be presented. Site search input terms may be entered and the search may be initiated using the search within a site search input interface.

The remainder of the “Detailed Description” is divided into three sections. A first section is entitled “Example Environments for Searching within a Site of a Search Result”. A second section is entitled “Example Implementations for Searching within a Site of a Search Result”. A third section is entitled “Example Device Implementations for Searching within a Site of a Search Result”.

### Example Environments for Searching Within a Site of a Search Result

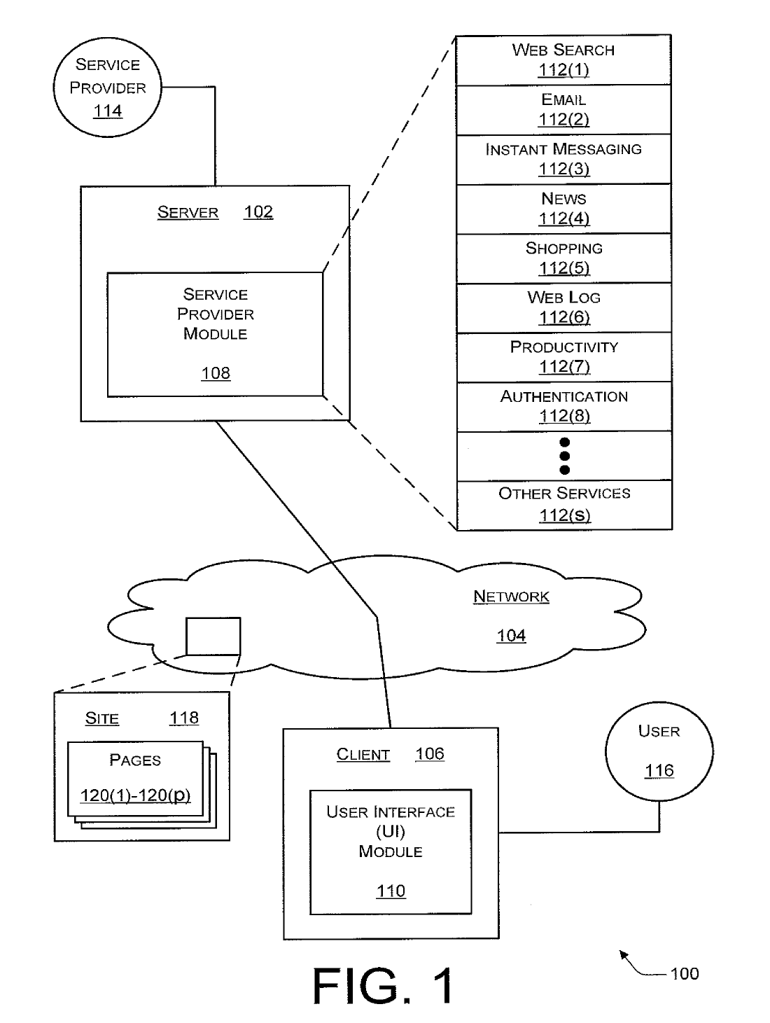

FIG. 1 is an example environment 100 in which searching within a site of a search result may be implemented. As illustrated, environment 100 includes a server 102, a network 104, and a client 106. Server 102 includes a service provider module 108. Client 106 includes a user interface (UI) module 110. Server 102 represents a service provider 114, and client 106 represents a user 116.

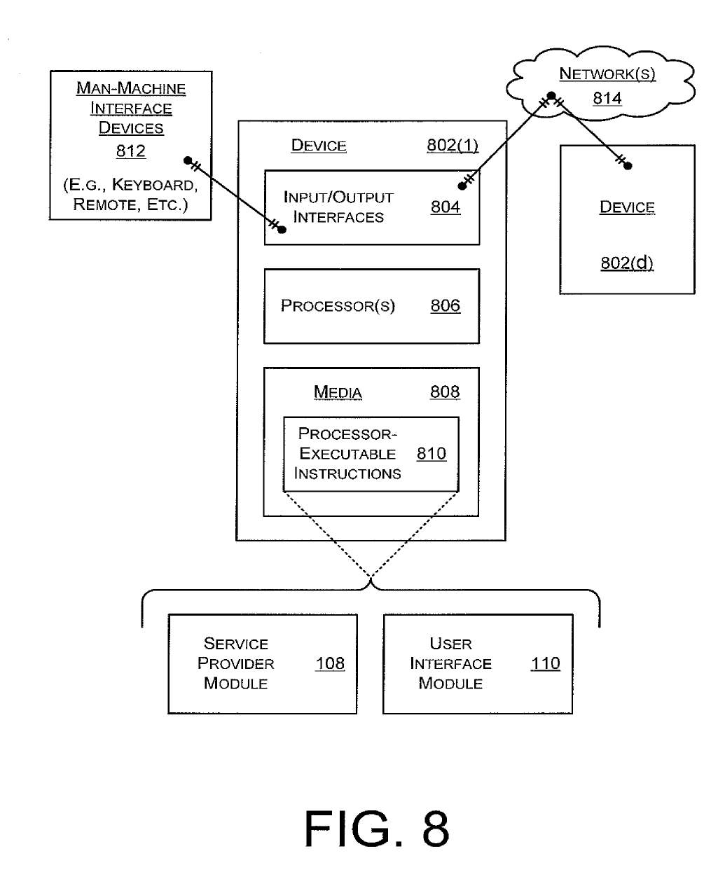

Although only a single server 102 and service provider 114 are explicitly illustrated in environment 100, multiple service providers 114 may exist, each with multiple servers 102. Similarly, although only a single client 106 and user 116 are shown, there may be multiple such clients 106 and/or users 116 that are being served by one or more servers 102. Server 102 and client 106 include processing and media resources that are sufficient to perform their respective functions as described herein. Example device hardware, software, etc. for a server 102 and/or a client 106 are described herein below with particular reference to FIG. 8.

Server 102 and client 106 communicate over network 104. Network 104 may be any given network or combination of networks. Examples include, but are not limited to, the internet, a telephone network, a cable network, a Wi-Fi network, a local or wide area network (a LAN or WAN), a wireless or wired network, some combination thereof, and so forth. However, in a described implementation, network 104 comprises at least the internet, and more specifically, the world wide web (WWW) portion of the internet.

Network 104 includes multiple network locations, as represented by the rectangle within network 104. In a described implementation, each location comprises a site 118. Each site 118 includes one or more pages 120. As illustrated, site 118 includes “p” pages 120(1) to 120(p), with “p” being some integer. Typically, a server (not explicitly illustrated) on network 104 hosts site 118 and serves pages 120. Each page 120 may have text images, audio/visual data, scripts, interactive content, data that is configured for consumption by a program (as opposed to being consumed by user 116), some combination thereof, and so forth. Although only a single site 118 is illustrated, network 104 likely has many such sites 118, each with its own pages 120.

Service provider module 108 is capable of providing one or more services 112 over network 104. Examples of such services include, but are not limited to, web search 112(1), email 112(2), instant messaging (IM) 112(3), news 112(4), shopping 112(5), web log 112(6), productivity 112(7), authentication 112(8) . . . other services 112(s), and so forth. Web search services 112(1) may include, for example, those services powered by a search engine that offer search results for searches of the web using input search terms. Web log services 112(6) may include those services that enable a user 116 to create a web log (blog).

Productivity services 112(7) may include services or applications that provide word processing, spread sheet formation, financial planning and analysis, audio/visual presentation development, some combination thereof, and so forth. Authentication services 112(8) may include services relating to proving that a person has certain access rights through, e.g., identification (ID) and password regimes. Other authentication service examples may include providing cryptographic services and/or evaluation of login ID and other identifying data (e.g., a finger print, an iris scan, etc.). Other services 112(s) represent other possible web-based services, such as those for entertainment, art, and so forth.

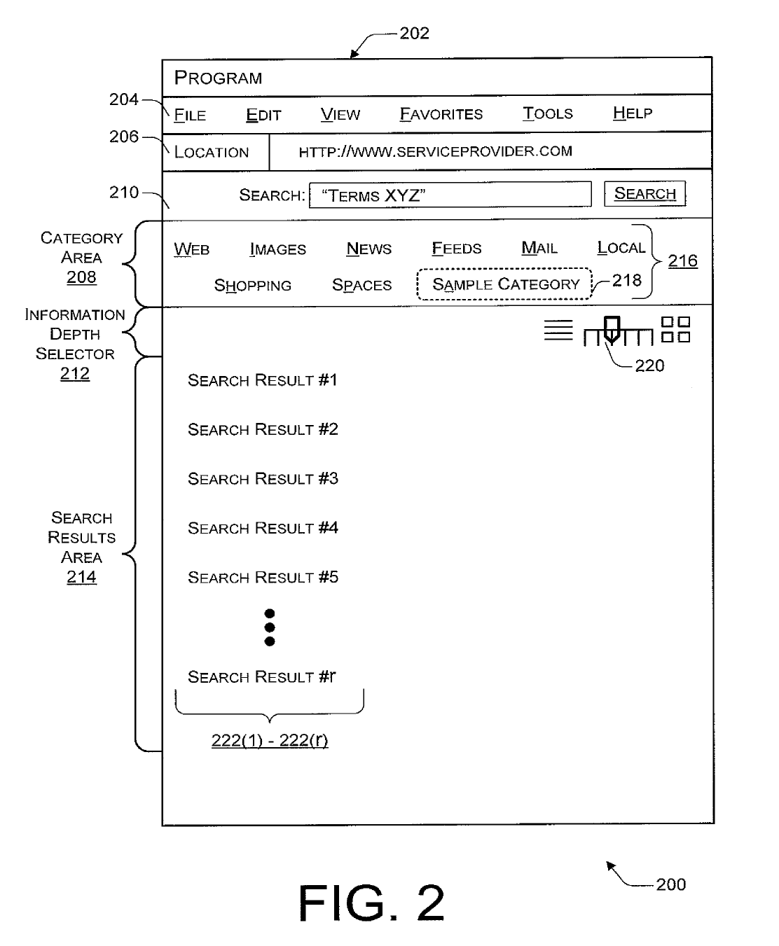

In a described implementation, service provider module 108, which executes on server 102, stores the data and performs the processing in order to provide services 112. Accordingly, client 106 can optionally be a relatively light-weight device with minimal processing and storage capabilities. UI module 110 executes on client 106 and presents a UI to user 116 on behalf of service provider module 108 in order to provide one or more services 112. The basics of an example UI are described below with particular reference to FIG. 2.

Although example implementations of searching within a site of a search result are described herein primarily in terms of a paradigm in which server 102 is responsible for the majority of the computing, searching within a site of a search result may be realized in alternative implementations. For example, client 106 may have significant processing, storage, and communications capabilities such that server 102 is only minimally involved or not involved at all, at least for services 112 that may be fully or partially self-hosted at client 106. For instance, client 106 may search stored emails and blogs without interaction across network 104.

Cooperation, interaction, and division of computing responsibilities between server 102 and client 106 may also be realized anywhere along a continuum having one end in which server 102 is primarily responsible for the computing and having another end in which client 106 is primarily responsible for the computing. In a web search scenario (e.g., involving a web search service 112(1)), service provider module 108 typically has access to a web index database and/or search engine, so it usually performs the search and provides the search results to UI module 110 for display and/or presentation by client 106 to user 116.

FIG. 2 is an example UI 200 having selectable categories 216 and a search results area 214 in which a site that is associated with a displayed search result 222 may itself be searched. UI 200 includes a program window 202. Examples for the program include, but are not limited to, a browser program, a general communication program, a general user interface or shell program, an operating system (OS) program, a productivity program, some combination thereof, and so forth. Especially depending on the type of underlying program, the illustrated aspects of program window 202 may be rearranged, some of the illustrated aspects may not be included, and/or other aspects may be added. Regardless, UI module 110 may comprise all or part of such an underlying program.

As illustrated, program window 202 includes a top-level menu bar 204, a location indicator bar 206, a category area 208, a search input area 210, an information depth selector 212, and search results area 214. The illustrated example menu components of top-level menu bar 204 are: File, Edit, View, Favorites, Tools, and Help. However, more, fewer, and/or different menu components may alternatively be present on top-level menu bar 204, especially depending on the underlying program. The location indicator bar 206, if included, has a dual purpose. First, it can be used to input a desired target location that is local or across a network. Second, it presents the location with which communication is currently established.

Category area 208 includes multiple categories 216. The illustrated example categories 216 are: web, images, news, feeds, mail, local, shopping, spaces, and sample category. Respective categories 216 may correspond to one or more services 112 (of FIG. 1). For example, web category 216 may correspond to web search 112(1), mail category 216 may correspond to email 112(2), shopping category 216 may correspond to shopping 112(5), spaces category 216 may correspond to web log 112(6), and so forth. Categories 216 may also be separate and/or different from the services 112 that are provided by service provider module 108. For instance, local category 216 may be directed to information that is stored locally at client 106.

Categories 216 may be presented as part of UI 200 in any of a variety of manners. They may simply be listed like the text of a menu bar. They may be represented as press-able buttons. They may be realized as tabs. Other manners may alternatively be implemented. Also, although categories 216 are illustrated as being represented by text, they may alternatively be represented by an icon (e.g., an envelope for mail, a bag for shopping, etc.), by both text and an icon, and so forth.

A category 216 of category area 208 may be selected as indicated by selection highlighting indicator 218. Generally, categories 216 may be selected or otherwise manipulated by a pointer input device, by a keyboard input device, by a combination thereof and so forth. Although selection highlighting indicator 218 is shown as a ring formed from a dashed line, selection can be indicated in alternative manners. Example alternative selection highlighting indication manners include, but are not limited to, visual brightening, inverse video, changing a background color or hue, having a button look depressed, having a tab be moved to the top, adding a check mark or other indicator, some combination thereof, and so forth.

A desired category 216 selection may be effectuated by a user 116 in any of a variety of manners. First, selection may be effectuated with keyboard commands (e.g., <Tab> key presses followed by pressing the <Enter> key). Second, selection may be effectuated with letters representing particular categories 216 (e.g., by pressing the underlined letter along with the <Alt> key). Third, selection may be effectuated with a pointer device (e.g., by moving a pointer icon in proximity to a desired category 216 and clicking a physical button on the pointer device). These selection effectuation mechanisms may be combined, and/or other alternatives may also be implemented.

Search input area 210 enables the input of search terms. As illustrated, it includes a box for search term input and a button to initiate the search. The example search term input is “Terms XYZ”. Search results area 214 includes the search results 222 that are output after using the search term input in a search of a given collection of information (e.g., a web index database).

Generally, search results area 214 includes “r” search results 222(1)-222(r), with “r” being some integer. Although search results 222 are displayed vertically in UI 200, they may be displayed in an alternative arrangement. Examples of such alternative arrangements include, but are not limited to, multiple columns, one or more rows, a grid, an infinite/smooth/smart scrolling display, some combination thereof and so forth.

Information depth selector 212 enables a user 116 to select the amount or depth of information that is displayed for each search result 222. As illustrated, information depth selector 212 is a slider bar 220. Slider bar 220 includes a pointer arrow that may be slid by a user to a number of different positions. Sliding the pointer arrow completely leftward causes search results 222 to be displayed in a relatively minimal format. Sliding the pointer arrow completely rightward causes search results 222 to be displayed in a relatively maximal format. There are intermediate positions in between the two. In an example implementation, the displayed search results 222 may be changed in response to sliding the pointer arrow without re-running the search (i.e., all of the data that would be displayed in a maximal format is initially retrieved for and provided to UI module 10 but may not be initially displayed by it).

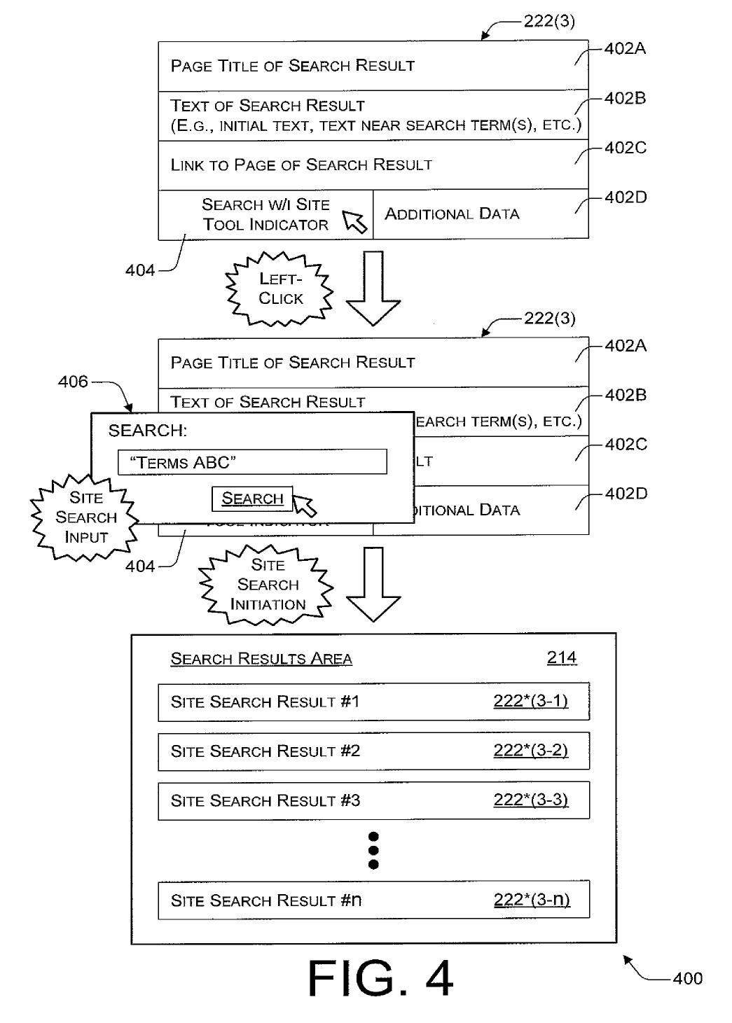

An example relatively minimal format may include the title of a corresponding search result page and an identifier (e.g., a network location) thereof. An example of a relatively maximal format may include for the corresponding search result page: the title, the network location, some initial text of the page, text around the words of the search terms, an image, and statistical information about the page. However, the maximal, the minimal, and the intermediate formats may include more, less, and/or different information. In a described implementation for searching within a site of a search result, at least the maximal format (and possibly other formats) include a search within a site tool indicator. Different examples for search within a site tool indicators are described herein below with particular reference to FIGS. 4-6.

Although information depth selector 212 is specifically illustrated as a slider bar 220, it may be realized with a different mechanism. For example, information depth selector 212 may be realized as a set of radio-style buttons. Also, a slider bar, a set of buttons, or another information depth selector mechanism may include detailed icons or text that describe or otherwise indicate the amount of information provided for each setting.

As illustrated, UI 200 presents category area 208 between search input area 210 and search results area 214 (e.g., below the former and above the latter). In a described implementation, category area 208 is presented after an input search term is entered and a search is initiated on the search term at search input area 210. However, category area 208 may alternatively also be presented prior to a search initiation. Although category area 208 may be presented in a different location, presenting it proximate to search results area 214 facilitates user utilization and interactivity when switching the selected category 216.

In a described implementation, the selected category 216, as visually represented by selection highlighter indicator 218, determines the context for a requested search. If the images category 216 is selected, the input search term “Terms XYZ” is applied to, for example, a database or index of data, that pertains to images. If the mail category 216 is selected, then the input search term “Terms XYZ” is applied to information pertaining to mail.

When a category selection is changed in category area 208, search results 222 that are displayed in search results area 214 are likewise changed. In other words, the output search results 222 for a search input of “Terms XYZ” are changed. For example, search results 222 from the images category 216 are replaced by search results 222 from the mail category 216 when selection highlighter indicator 218 is moved from “Images” to “Mail”.

### Example Implementations for Searching Within a Site of a Search Result

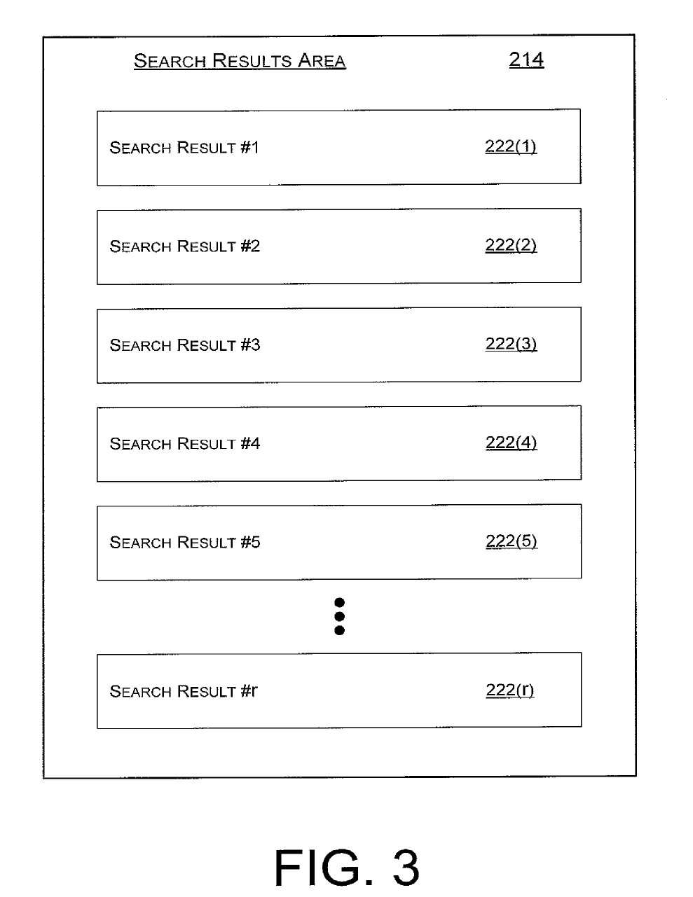

FIG. 3 is a block diagram of a more general example of a search results area 214 in which a site that is associated with a displayed search result 222 may itself be searched. The description above with particular reference to FIG. 2 is directed to a specific UI paradigm. However, the searching within a site of a search result that is described herein is not limited to any particular UI paradigm.

The block diagram of FIG. 3 illustrates a general search results area 214. Search results area 214 may be part of any given UI. For example, search results area 214 may comprise all or part of any given window, all or part of any given pane of a window, some combination thereof, and so forth.

As illustrated, search results area 214 includes the “r” search results 222(1)-222(r). Specifically, search results area 214 includes search result #1 222(1), search result #2 222(2), search result #3 222(3), search result #4 222(4), search result #5 222(5) . . . search result #r 222(r). In FIG. 3, each search result 222 is indicated by a block formed from a relatively thin line. Although such a thin-line box need not actually be displayed around each search result 222 (and usually search results are not surrounded by boxes), the thin-line boxes are included in FIGS. 3-6 for the sake of clarity to separate different conceptual elements.

FIG. 4 is a block diagram 400 of a search result 222(3) for a page on a site in which a user interface enables the site to be searched. Search result 222(3) corresponds to a page 120 (of FIG. 1) that is located on a network site 1118, such as a web site of network 104. Thus, in a described implementation, search result 222(3) corresponds to a page 120, and page 120 is associated with a site 118 on which page 120 is located. Site 118 corresponds to a domain of network 104 that typically has multiple pages 120.

As illustrated at the top of block diagram 400, search result 222(3) includes multiple parts 402. These parts include: a page title of the search result 402A, text of the search result 402B, a link to the page of the search result 402C, additional data 402D, and so fort. The text of the search result 402B may be the initial text of the corresponding page, text near target search terms within the corresponding page, some combination thereof, and so forth.

Under current internet standards, a link to a page 120 (e.g., the link to the page corresponding to the search result 402C) adheres to the following format: “http:://www.companyname.com/pagealphabeta”. With such a format, the associated site 118 or domain is “www.companyname.com”. However, networks operating under different and/or newer standards may utilize different terminology and/or syntax to indicate and/or demarcate the network locations of sites 118 and pages 120. Additional data 402D may include data about the corresponding page 120, such as size, content data type(s), last date visited, and so forth.

Each search result 222(3) may alternatively include more, fewer, and/or different parts 402. In a UI paradigm such as the UI 200 of FIG. 2, the parts 402 of search result 222(3) that are displayed may be selected by user 116 with information depth selector 212.

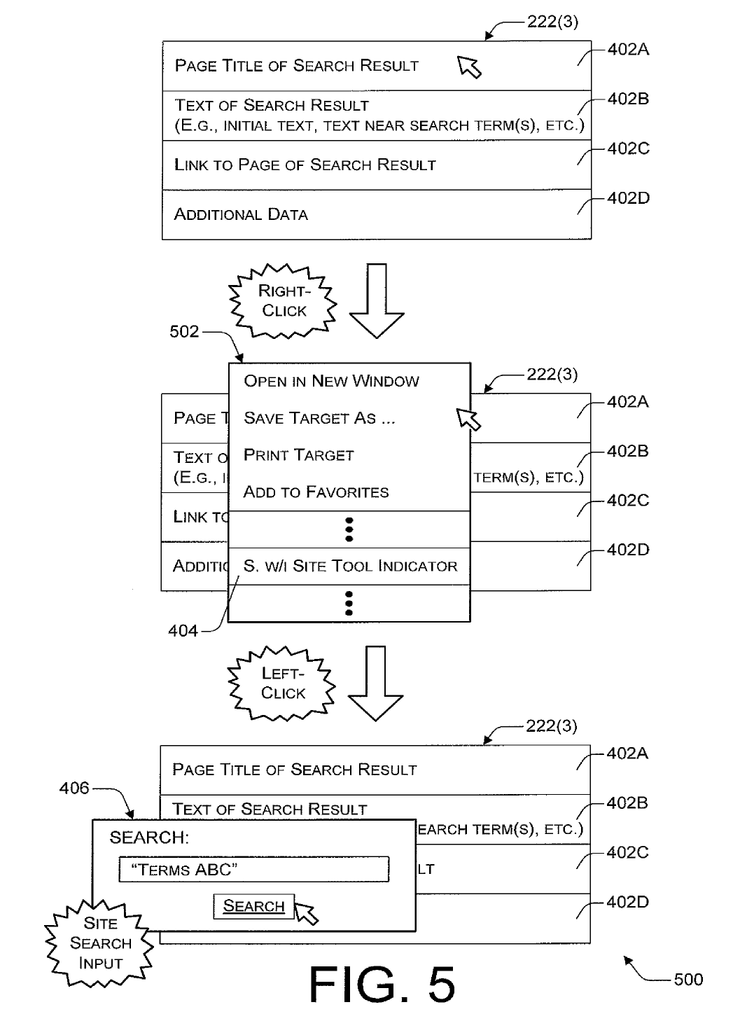

Continuing with the top of block diagram 400, a search within a site tool indicator 404 is shown. In the example of FIG. 4, search within a site tool indicator 404 is another part of search result 222(3). However, in alternative implementations, search within a site tool indicator 404 may be separate from the search result 222(3) to which it is associated (e.g., as shown in FIG. 5). Search within a site tool indicator 404 may include text, graphics (e.g., an icon), a button, a link, some combination thereof, and so forth.

The search within a site tool indicator 404 is activated so as to activate the search within a site feature. It may be activated by a pointer input device, by a keyboard input device (e.g., with key or key combination presses), by some combination thereof, and so forth. Example user effectuation mechanisms for UI features are described herein above with regard to effectuating selection of categories 216 (of FIG. 2). A pointer icon is illustrated in block diagram 400. The pointer icon, which is shown as an arrow, is proximate to search within a site tool indicator 404. By way of example only, the search within a site tool indicator 404 may be activated by a pointer input device such as a mouse (e.g., with a left-click).

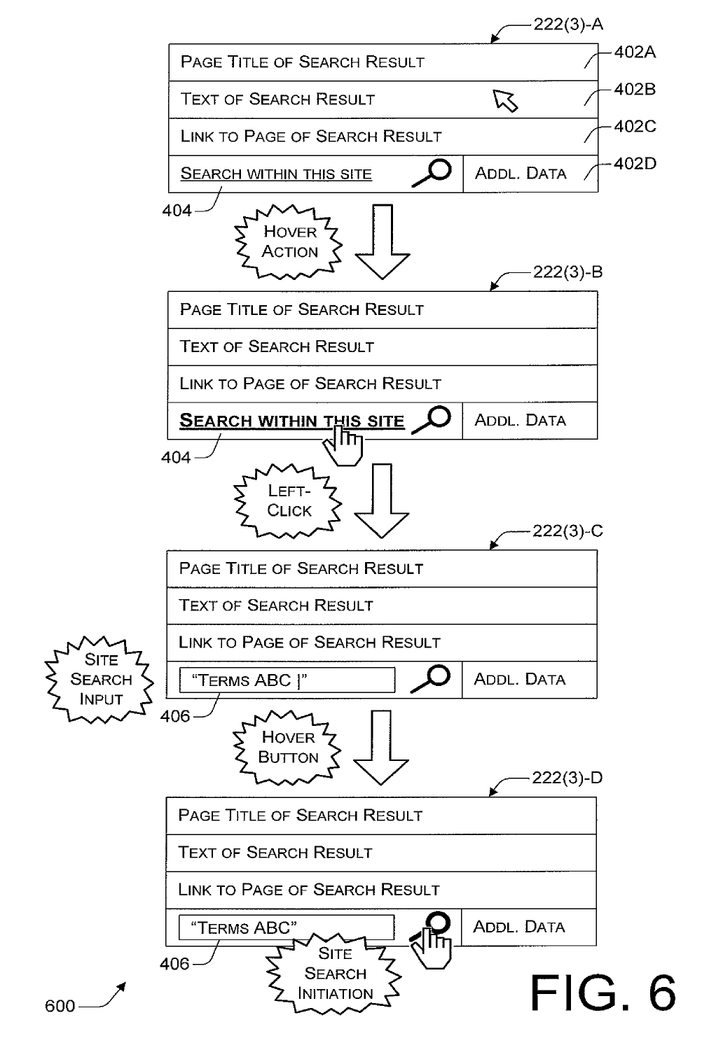

As illustrated in the middle of block diagram 400, activation of search within a site tool indicator 404 causes or precipitates the presentation of a site search input interface 406. In the example of block diagram 400, site search input interface 406 is a window (e.g., a pop-up window). However, site search input interface 406 may be presented to a user 116 in an alternative manner, one of which is described herein below with particular reference to FIG. 6.

In a described implementation, site search input interface 406 includes at least a site search input block and a search initiation button. The example site search input term is “Terms ABC”. When the site search is initiated, the site search input term(s) are applied to the site 118 associated with the page 120 corresponding to search result 222(3). The search is initiated at the middle of block diagram 400 when the “Search” button is ‘pressed’ to effectuate the “Search” UI feature.

At the bottom of block diagram 400, the site search results 222* are displayed. Site search results 222*(3) correspond to pages 120 from the site 118 that also has the page 120 corresponding to search result 222(3). More specifically, site search results 222*(3) are those pages 120 from the associated site 118 that are found responsive to a search of site 118 using the site search input terms. In operation, a search engine (e.g., of web search service 112(1)) applies the site search input terms to a search database and focuses the search and/or the search results on those pages 120 that are part of the associated site 118.

In a described implementation, site search results 222*(3) are displayed within search results area 214. However, site search results 222* may alternatively be displayed in a different search results area 214*. As illustrated, “n” site search results 222*(3-1) to 222*(3-n) are shown. Specifically, search results area 214 includes site search result #1 222*(3-1), site search result #2 222*(3-2), site search result #3 222*(3-3) . . . site search result #n 222*(3-n).

FIG. 5 is another block diagram 500 of a search result 222(3) for a page on a site in which a user interface enables the site to be searched. Search result 222(3) is illustrated at the top part of block diagram 500. Initially, a search within a site tool indicator 404 is not visible as being part of or associated with search result 222(3). However, a search within a site tool indicator 404 that is associated with search result 222(3) may be commanded to be presented.

In the example of block diagram 500, a search within a site tool indicator 404 is commanded to appear with a right-click pointer device input. A pointer icon, which is represented as an arrow, is shown as being proximate to (including covering) search result 222(3). A right-click over search result 222(3) causes a pop-up menu to be presented. The location of the pointer icon during the right-click may be limited to a particular part or parts 402 or may be permitted anywhere in the vicinity of search result 222(3).

At the middle of block diagram 500, a pop-up menu 502 is shown. As illustrated, pop-up menu 502 includes a number of menu options. These illustrated menu options are “Open in New Window”, “Save Target As . . . ”, “Print Target”, “Add to Favorites”, and “Search within a Site Tool Indicator”. In alternative implementations, more, fewer, and/or different menu options may be included as part of pop-up menu 502. For example, pop-up menu 502 may only include search within a site tool indicator 404.

Although a right-click user input mechanism is described herein, other user input mechanisms (e.g., a keyboard press or presses) may also be used to command the presentation of search within a site tool indicator 404. After commanding search within a site tool indicator 404 to be presented, the search within a site tool may be activated. For example, the pointer icon may be moved to search within a site tool indicator 404, and the pointer input device may be left-clicked. The <Tab> key, the arrow keys, and/or the <Enter> key, etc. may alternatively be used to activate search within a site tool indicator 404.

After search within a site tool indicator 404 is activated, site search input interface 406 is presented. As described herein above with particular reference to FIG. 4, a site search input may be entered with site search input interface 406. Also, a site search for the associated site 118 may be initiated by ‘pressing’ the “Search” button.

FIG. 6 is yet another block diagram 600 of a search result 222(3) for a page on a site in which a user interface enables the site to be searched. Four search results 222(3)-A, 222(3)-B, 222(3)-C, and 222(3)-D are shown in block diagram 600 in different phases for a search-within-a-site-of-a-search-result feature.

As shown at the top of block diagram 600 at search result 222(3)-A, another example implementation of a search within a site tool indicator 404 is illustrated. In block diagram 600, search within a site tool indicator 404 includes text and an icon-based button. The text is “Search within this site” and is underlined to indicate that it may be activated. The icon is a magnifying glass to represent a search feature. The pointer icon is “originally” represented as an arrow.

At search result 222(3)-B, the pointer icon has been moved over search within a site tool indicator 404. This establishes a hover action and transforms the arrow into a finger-pointing hand. Additionally, search within a site tool indicator 404 is changed. As illustrated, the text is changed. For example, the text may be changed in color, font size, character style, boldings no-underlining-to-underling, some combination thereof, and so forth. As shown, the text is bolded and increased in font size. Alternatively, the text may be replaced with other text and/or a graphic element. The search within a site tool indicator 404 may then be activated.

By way of example only, a left-click activates search within a site tool indicator 404 at search result 222(3)-C. The activation causes a site search input interface 406 to be presented as embedded in search result 222(3). As illustrated, site search input interface 406 of block diagram 600 includes a block for site search text input and the icon-based button. It at least partially replaces search within a site tool indicator 404. User 116 has entered site search input of “Terms ABC” at search result 222(3)-C. After entry of the first character, active input can predict the remainder of the site search input, and the user can elect to select the predicted text or to continue typing.

At search result 222(3)-D, the pointer icon has been moved over to the icon-based button of site search input interface 406. This establishes a hover button that may be ‘pressed’ to initiate the site search with regard to the site search input of “Terms ABC” and with reference to the site 118 that is associated with search result 222(3). After site search initiation, site search results 222*(3) are displayed as illustrated in the bottom portion of block diagram 400 (of FIG. 4).

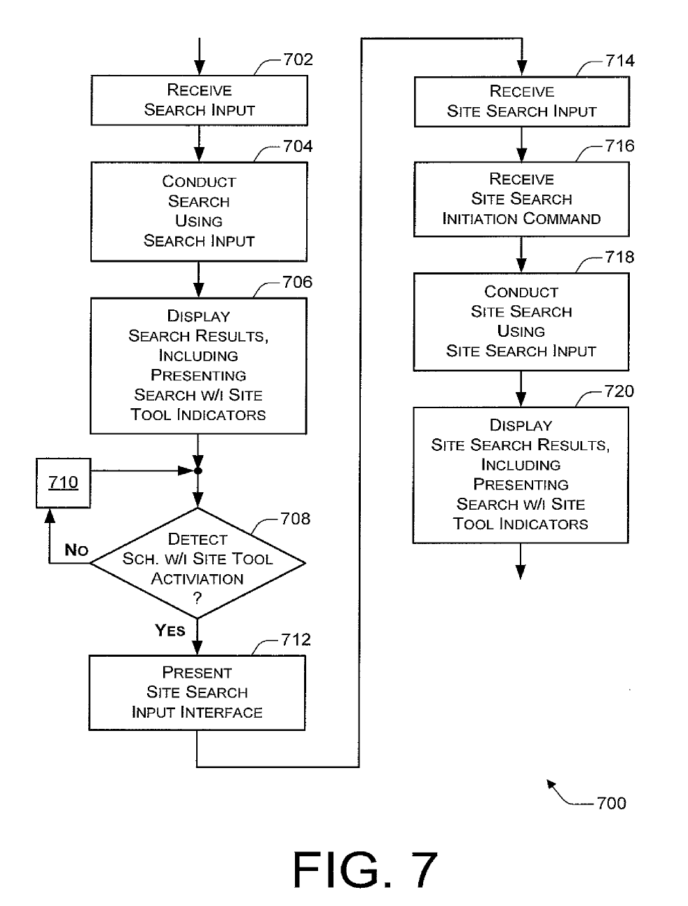

FIG. 7 is a flow diagram 700 that illustrates an example of a method for searching a site of a page that corresponds to a displayed search result. Flow diagram 700 includes ten (10) blocks 702-720. Although the actions of flow diagram 700 may be performed in other environments and with a variety of hardware and software combinations, a service provider module 108 and/or a UI module 110, either separately or jointly, may be used to implement the method of flow diagram 700 in conjunction with a UI and a search capability.

At block 702, a search input is received. For example, a general search input (e.g., “Terms XYZ”) may be received at search input area 210 (of FIG. 2). At block 704, a search is conducted using the received search input. For example, a search on a general database index for a network 104 (of FIG. 1) may be conducted with regard to “Terms XYZ”.

At block 706, the search results are displayed, including presenting search within a site tool indicators. For example, search results 222 may be displayed in a search results area 214 (of FIG. 3). Each search result 222 may be associated with a search within a site tool indicator 404 (of FIGS. 4-6). The associated search within a site tool indicator 404 may be presented when search results 222 are displayed (e.g., as shown in FIGS. 4 and 6) or upon user command (e.g., as shown in FIG. 5).

At block 708, it is detected if a search within a site tool (indicator) has been activated. For example, it may be detected if a search within a site tool indicator 404 is activated by a mouse click, a keyboard input, some combination thereof, and so forth.

If a search within a site tool indicator is not detected to be activated (at block 708), then any of a number of actions may be performed at block 710. For example, monitoring to detect activation of a search within a site tool indicator 404 may be continued. Furthermore, other UI features and options may be monitored. These UI features and options may include, for instance, conducting a new search at search input area 210, displaying a page 120 corresponding to a selected search result 222, changing categories 216 and the search results 222 that are displayed as a result of the selected category 216 (e.g., if the UI 200 paradigm of FIG. 2 is being employed), and so forth.

If, on the other hand, activation of a search within a site tool indicator is detected (at block 708), then the method of flow diagram 700 continues at block 712. For example, activation of a particular search within a site tool indicator 404 that is associated with a particular search result 222(3) may be detected. At block 712, a site search input interface is presented. For example, a site search input interface 406 may be presented to a user 116. For instance, a site search input interface 406 that is associated with the particular search result 222(3) may be activated. In this example, the particular search result 222(3) corresponds to a page 120 that is part of and associated with a site 118.

At block 714, a site search input is received. For example, a site search input of “Terms ABC” may be received at site search input interface 406. At block 716, a site search initiation command is received. For example, a command to initiate a site search may be received from a user 116 via a “Search” button (e.g., of FIGS. 4 and 5) or an icon-based hover button (e.g., of FIG. 6) in a site search input interface 406.

At block 718, a site search is conducted using the site search input. For example, a site search on the domain of the associated site 218 may be conducted using the site search input of “Terms ABC”. At block 720, the site search results are displayed, optionally including presenting search within a site tool indicators. For example, site search results 222*(3) corresponding to pages 120 from associated site 118 may be displayed. These site search results 222*(3) may also each be associated with a respective search within a site tool indicator 404, or the entire set or collection of site search results 222*(3) may be associated with a single search within a site tool indicator because each respective page 120 corresponding to a respective site search result 222*(3) is already from a single site 118.

### Example Device Implementations for Searching Within a Site of a Search Result

FIG. 8 is a block diagram of an example device 802 that may be employed in conjunction with searching within a site of a search result. For example, a device 802 may realize, execute, or otherwise implement a UI and/or a search within a site of a search result feature as described herein above. In certain implementations, devices 802 are capable of communicating across one or more networks 814, such as network 104 (of FIG. 1). As illustrated, two devices 802(1) and 802(d) are capable of engaging in communication exchanges via network 814. Example relevant communication exchanges include those between a server 102 and a client 106 relating to providing services 112.

Generally, device 802 may represent a server or a client device; a storage device; a workstation or other general computer device; a set-top box or other television device; a personal digital assistant (PDA), mobile telephone, or other mobile appliance; some combination thereof; and so forth. As illustrated, device 802 includes one or more input/output (I/O) interfaces 804, at least one processor 806, and one or more media 808. Media 808 includes processor-executable instructions 810. Although not specifically illustrated, device 802 may also include other components.

In a described implementation of device 802, I/O interfaces 804 may include (i) a network interface for communicating across network(s) 814, (ii) a display device interface for displaying information on a display screen, (iii) one or more man-machine device interfaces, and so forth. Examples of (i) network interfaces include a network card, a modem, one or more ports, and so forth. Examples of (ii) display device interfaces include a graphics driver, a graphics card, a hardware or software driver for a screen/television or printer, etc. to create a UT. Examples of (iii) man-machine device interfaces include those that communicate by wire or wirelessly to man-machine interface devices 812 (e.g., a keyboard or keypad, a mouse or other graphical pointing device, a remote control, etc.) to manipulate and interact with a UT.

Generally, processor 806 is capable of executing, performing, and/or otherwise effectuating processor-executable instructions, such as processor-executable instructions 810. Media 808 is comprised of one or more processor-accessible media. In other words, media 808 may include processor-executable instructions 810 that are executable by processor 806 to effectuate the performance of functions by device 802.

Thus, realizations for searching within a site of a search result may be described in the general context of processor-executable instructions. Generally, processor-executable instructions include routines, programs, applications, coding, modules, protocols, objects, interfaces, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 806 may be implemented using any applicable processing-capable technology. Media 808 may be any available media that is included as part of and/or accessible by device 802. It includes volatile and non-volatile media, removable and non-removable media, and storage and transmission media (e.g., wireless or wired communication channels). For example, media 808 may include an array of disks for longer-term mass storage of processor-executable instructions, random access memory (RAM) for shorter-term storage of instructions that are currently being executed, flash memory for medium to longer term storage, optical disks for portable storage, and/or link(s) on network 814 for transmitting code or other communications, and so forth.

As specifically illustrated, media 808 comprises at least processor-executable instructions 810. Generally, processor-executable instructions 810, when executed by processor 806, enable device 802 to perform the various functions described herein. Examples include, but are not limited to, those functions of a service provider module 108 and/or a UI module 110 (of FIG. 1); those aspects of the UI 200 paradigm (of FIG. 2); those features provided and/or enabled by the UI block diagrams 400, 500, and 600 (of FIGS. 4, 5, and 6, respectively); those actions of block diagram 700 (of FIG. 7); some combination thereof, and so forth.

The devices, actions, aspects, features, functions, procedures, modules, data structures, schemes, approaches, UIs, architectures, components, etc. of FIGS. 1-8 are illustrated in diagrams that are divided into multiple blocks. However, the order, interconnections, interrelationships, layout, etc. in which FIGS. 1-8 are described and/or shown are not intended to be construed as a limitation, and any number of the blocks can be modified, combined, rearranged, augmented, omitted, etc. in any manner to implement one or more systems, methods, devices, procedures, media, apparatuses, APIs, arrangements, etc. for searching within a site of a search result.

Although systems, media, devices, methods, procedures, apparatuses, techniques, schemes, approaches, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. One or more processor-accessible media comprising processor-executable instructions that, when executed, cause a device to perform actions comprising:
displaying multiple search results, the multiple search results including a particular search result that corresponds to a given page from a particular site; and
presenting a search within a site tool indicator in association with the particular search result.

2. The one or more processor-accessible media as recited in claim 1, wherein the processor-executable instructions, when executed, cause the device to perform a further action comprising:
receiving a user command to present the search within a site tool indicator;
wherein the presenting action is performed in response to the receiving action.

3. The one or more processor-accessible media as recited in claim 1, wherein the presenting action is performed as part of the displaying action.

4. The one or more processor-accessible media as recited in claim 1, wherein the processor-executable instructions, when executed, cause the device to perform further actions comprising:
detecting activation of the search within a site tool indicator; and
responsive to the detecting, presenting a site search input interface.

5. The one or more processor-accessible media as recited in claim 4, wherein the processor-executable instructions, when executed, cause the device to perform further actions comprising:
receiving a site search input via the site search input interface;
conducting a site search with regard to the site search input and with reference to the particular site; and
displaying multiple site search results produced from the conducting, each site search result of the multiple site search results corresponding to a page from the particular site.

6. The one or more processor-accessible media as recited in claim 1, wherein the search within a site tool indicator enables a user to have a search performed on the particular site.

7. One or more processor-accessible media comprising processor-executable instructions that, when executed, cause a device to display a user interface, the user interface comprising:
a search results area that includes multiple search results; and
at least one search within a site tool indicator that is associated with at least one search result of the multiple search results.

8. The one or more processor-accessible media as recited in claim 7, wherein activation of the at least one search within a site tool indicator causes a site search input interface to be presented in which a user may input one or more site search terms.

9. The one or more processor-accessible media as recited in claim 8, wherein the site search input interface enables the user to initiate a site search.

10. The one or more processor-accessible media as recited in claim 9, wherein the at least one search result corresponds to a given page that is part of a particular site; and wherein the site search is directed to multiple pages located on the particular site with regard to the one or more site search terms.

11. The one or more processor-accessible media as recited in claim 10, wherein the particular site is represented by an internet domain.

12. The one or more processor-accessible media as recited in claim 8, wherein the site search input interface comprises a pop-up window.

13. The one or more processor-accessible media as recited in claim 8, wherein the site search input interface comprises an input box that replaces at least part of the at least one search within a site tool indicator.

14. The one or more processor-accessible media as recited in claim 7, wherein the at least one search within a site tool indicator comprises part of the at least one search result as displayed by the user interface.

15. The one or more processor-accessible media as recited in claim 7, wherein the at least one search within a site tool indicator can be commanded by a user to be presented by the user interface in association with the at least one search result.

16. A method comprising:
displaying multiple search results, including presenting at least one search within a site tool indicator that enables a search to be performed on a particular site;
detecting activation of the at least one search within a site tool indicator; and
responsive to the detecting, presenting a site search input interface.

17. The method as recited in claim 16, further comprising;
receiving a site search input via the site search input interface; and
conducting a site search on the particular site using the site search input.

18. The method as recited in claim 17, further comprising:
responsive to the conducting, displaying multiple site search results that are found on the particular site.

19. The method as recited in claim 17, wherein:
the detecting comprises detecting activation of the at least one search within a site tool indicator that is associated with a particular search result of the multiple search results, the particular search result corresponding to a particular page that is located on the particular site; and
the conducting comprises conducting the site search on pages of the particular site using the site search input.

20. The method as recited in claim 16, wherein the presenting a site search input interface comprises:
presenting the site search input interface as a pop-up window; or
presenting the site search input interface embedded with at least one search result of the multiple search results.
